(19) United States
(12) Patent Application Publication
(10) Pub. No.: US 2020/0012028 A1
(43) Pub. Date: Jan. 9, 2020

(54) ELECTRONIC DEVICE

(71) Applicant: InnoLux Corporation, Miao-Li County (TW)

(72) Inventors: Hsiao-Lang Lin, Miao-Li County (TW); Tsung-Han Tsai, Miao-Li County (TW); Kuan-Feng Lee, Miao-Li County (TW)

(21) Appl. No.: 16/026,058

(22) Filed: Jul. 3, 2018

(51) Int. Cl. G02B 5/30; G02F 1/1335; G02F 1/1362

(52) U.S. Cl. CPC G02B 5/3058; G02F 1/133528; G02F 2001/133548; G02F 1/136286; G02F 1/133512

(57) ABSTRACT

The present disclosure provides an electronic device including a substrate, a grid structure, and a plurality of polarizing wires. The grid structure is disposed on the substrate and includes a plurality of apertures. The polarizing wires are disposed on the substrate and extend across the apertures. A transmittance of one of the apertures in a wavelength range from 510 nm to 550 nm is ranged from 27% to 57%, or a transmittance of one of the plurality of apertures in a wavelength range from 610 nm to 650 nm is ranged from 29% to 57%.

### BACKGROUND OF THE DISCLOSURE

### 1. Field of the Disclosure

The present disclosure relates to an electronic device, and more particularly, to an electronic device including polarizing wires.

### 2. Description of the Prior Art

Electronic device, such as a liquid crystal display device (LCD) or other functional electronic device, includes an array circuit for driving functional units, such as pixels, in the device. It is known that a plurality of scan lines, a plurality of data lines or a plurality of transistors of the array circuit may be defective upon manufacturing. The defect may cause the functional unit to appear improper results. Thus, a laser repairing process is required.

However, conventional polarizing films adhered on outer surface of the electronic device have worse transmittance, so the intensity of repairing laser may be reduced Besides, bubbles in the conventional polarizing film may generate while the conventional polarizing film is at high temperature and high humidity. Thus, a new polarizing design is required.

### SUMMARY OF THE DISCLOSURE

According to an embodiment, the present disclosure provides an electronic device including a substrate, a grid structure, and a plurality of polarizing wires. The grid structure is disposed on the substrate and includes a plurality of apertures. The polarizing wires are disposed on the substrate and extend across the apertures. A transmittance of one of the apertures in a wavelength range from 510 nm to 550 nm is ranged from 27% to 57%. A transmittance of another one of the apertures in a wavelength range from 610 nm to 650 nm is ranged from 29% to 57%

According to another embodiment, the present disclosure provides an electronic device including a substrate, a plurality of scan lines, a plurality of data lines, a black matrix and a plurality of polarizing wires. The scan lines are disposed on the substrate, the data lines are disposed on the substrate, and the black matrix is disposed on the substrate and includes a plurality of apertures. The polarizing wires are disposed on the substrate and extend across the plurality of apertures. A transmittance of one of the apertures in a wavelength range from 510 nm to 550 nm is ranged from 27% to 57%. A transmittance of another one of the apertures in a wavelength range from 610 nm to 650 nm is ranged from 29% to 57%

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a top view of a first array substrate of an electronic device according to a first embodiment of the present disclosure.

FIG. 2 schematically illustrates a cross-sectional view of the first array substrate along a line Y-Y′ shown in FIG. 1.

FIG. 3 shows a method for measuring the transmittance of the aperture according to the present disclosure.

FIG. 4 schematically illustrates a top view of a first array substrate according to a variant embodiment of the first embodiment of the present disclosure.

FIG. 5 schematically illustrates a top view of a first array substrate according to a variant embodiment of the first embodiment of the present disclosure.

FIG. 6 schematically illustrates a cross-sectional view of the first array substrate along a line Z-Z′ shown in FIG. 5.

FIG. 7 schematically illustrates a top view of a first array substrate according to a variant embodiment of the first embodiment of the present disclosure.

FIG. 8 schematically illustrates a cross-sectional view of a first array substrate according to a second embodiment of the present disclosure.

FIG. 9 schematically illustrates a top view of a first array substrate according to a third embodiment of the present disclosure.

FIG. 10 schematically illustrates atop view of a second array substrate according to a fourth embodiment of the present disclosure.

FIG. 11 schematically illustrates a cross-sectional view of the second array substrate shown in FIG. 10.

FIG. 12 schematically illustrates a cross-sectional view of a second array substrate according to a fifth embodiment of the present disclosure.

FIG. 13 schematically illustrates a cross-sectional view of a second array substrate according to a sixth embodiment of the present disclosure.

FIG. 14 schematically illustrates a top view of a first array substrate according to a seventh embodiment of the present disclosure.

FIG. 15 schematically illustrates a cross-sectional view of the first array substrate taken along a line A-A′ shown in FIG. 14.

FIG. 16 schematically illustrates a cross-sectional view of a first array substrate according to an eighth embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the electronic device, and certain elements in various drawings may not be drawn to scale. In addition, the number and dimension of each element shown in drawings are only illustrative and are not intended to limit the scope of the present disclosure.

Certain terms are used throughout the description and following claims to refer to particular elements. As one skilled in the art will understand, electronic equipment manufacturers may refer to an element by different names. This document does not intend to distinguish between elements that differ in name but not function. In the following description and in the claims, the terms “include”, “comprise” and “have” are used in an open-ended fashion, and thus should be interpreted to mean “include, but not limited to . . . ”.

It will be understood that when an element or layer is referred to as being “disposed on” or “connected to” another element or layer, it can be directly on or directly connected to the other element or layer, or intervening elements or layers may be presented (indirectly). In contrast, when an element is referred to as being “directly on” or “directly connected to” another element or layer, there are no intervening elements or layers presented.

Although terms such as first, second, third, etc., maybe used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

It should be noted that the technical features in different embodiments described in the following can be replaced, recombined, or mixed with one another to constitute another embodiment without departing from the spirit of the present disclosure.

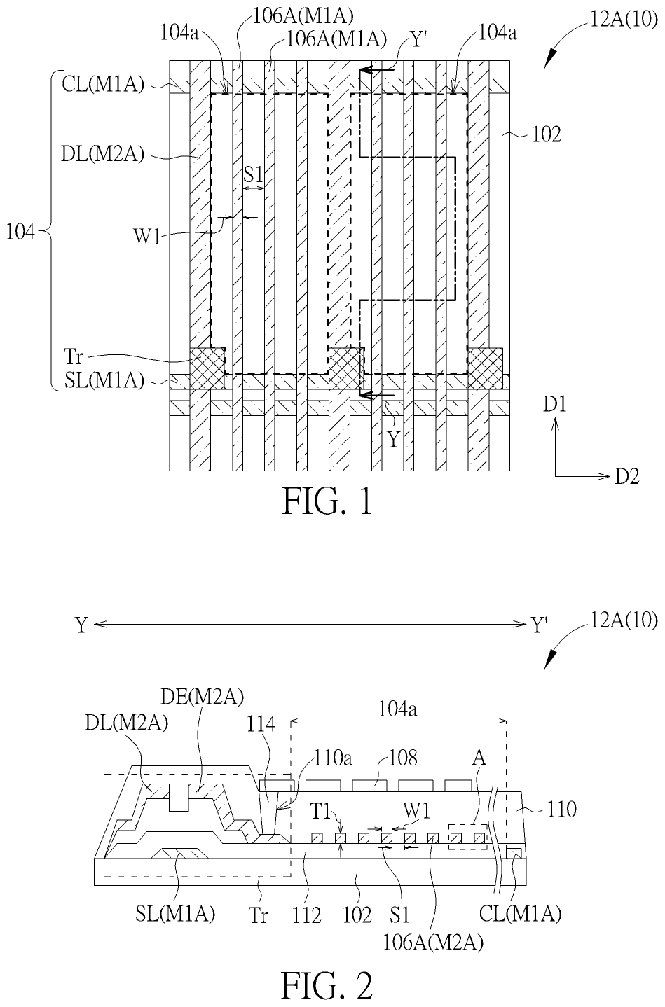

Refer to FIG. 1 and FIG. 2. FIG. 1 schematically illustrates a top view of a first array substrate of an electronic device according to a first embodiment of the present disclosure, and FIG. 2 schematically illustrates a cross-sectional view of the first array substrate taken along a line Y-Y′ shown in FIG. 1. The electronic device includes a substrate 102, a grid structure 104 and a plurality of polarizing wires 106A. The grid structure 104 encloses a plurality of apertures 104a, and the polarizing wires 106A extend across the apertures 104a. The grid structure 104 is light shielded as a frame of apertures, and apertures 104a are light passing openings in the grid structure 104 allow light penetrating through. The polarizing wires 106A are formed of opaque conductive, semi-conductive or insulating materials and used for modulating polarizing state of light while the light penetrating through the polarizing wires 106A. In other words, the polarizing wires 106A serve as a polarizer. The polarizing wires 106A may be disposed at several positions of the electronic device. Further, the substrate 102 maybe formed of a rigid or flexible substrate. According to some embodiments, the electronic device can be for example a display device, such as liquid crystal display device (LCD), organic light-emitting display device (OLED) or inorganic light-emitting display device, a sensing device, a transceiver, or an antenna, such as a liquid crystal antenna. The number of the polarizing wires 106A in each aperture 104a shown in FIG. 1 and FIG. 2 is only illustrative and is not limited thereto.

In this embodiment, the electronic device is a display device 10, in which the grid structure 104 and the polarizing wires 106A are formed on the same substrate 102. The grid structure 104 is formed by light-shielding elements of the first array substrate 12A as a mesh or net shape pattern in a top view. Thus, each aperture 104a enclosed by the light-shielding elements of the grid structure 104, and at least a portion of the polarizing wires 106A are disposed therein in a top view. In this embodiment, the light-shielding elements may for example include scan lines SL, common lines CL, data lines DL and transistors Tr. Since the scan lines SL, the common lines CL, the data lines DL and part of the transistors Tr are formed by metal layers. In such arrangement, a kind of aperture 104a may be formed and enclosed by one of the scan lines SL, one of the common lines CL, adjacent two of the data lines DL and a part of one of the transistors Tr, but the present disclosure is not limited thereto. In some embodiment, without common lines CL, another kind of aperture 104a may be formed and enclosed by adjacent two scan lines SL, adjacent two data lines DL and a part of one of the transistors Tr. For example, one of the apertures 104a may correspond to one display region for generating one color of light, such as a pixel or a sub-pixel, but the present disclosure is not limited thereto. Based on different arrangements of the light-shielding elements in the array circuit, the definition of the aperture may be different. In another embodiment, when one of signal lines, such as the data line, the scan line or the common line, crosses the display region to separate the display region into two sub-regions for generating the same color of light, one of the apertures is regarded as one of the sub-regions. In this embodiment, the first array substrate 12A may include a passivation layer 110, and the passivation layer 110 may have a plurality of through holes 110a, each of which is filled with a contact element 114, so as to electrically connect the pixel electrode 108 and the drain DE of the transistor Tr. Also, in order to avoid signal interference of the floating polarizing wires, the polarizing wires 106A may be electrically connected to one of the common lines CL or may be grounded. But, floating polarizing wires may be also acceptable.

In order to clarify a transmittance of aperture 104a, following description takes one aperture 104a as an example, but not limited thereto. In one of the apertures 104a, since no light-shielding elements of grid structure 104 are disposed in the aperture 104a except the polarizing wires 106A, the transmittance of the aperture 104a maybe adjusted by the design of the polarizing wires 106A. The laser light used in repairing process may be in a wavelength range from 510 nm to 550 nm or in a wavelength range from 610 nm to 650 nm; that is the laser light may be green or red. The laser light for repairing in the wavelength range from 510 nm to 550 nm may be for example generated from a neodymium-doped yttrium aluminum garnet (Nd:YAG) laser, a gas laser, such as argon-ion laser, or a semiconductor laser including indium gallium nitride, aluminum(III) oxide(Al₂O₃) or zinc selenide. The laser light in the wavelength range from 610 nm to 650 nm may be for example generated from a semiconductor laser including aluminum gallium indium phosphide, gallium indium phosphide or gallium arsenide. In the present disclosure, the transmittance of the aperture 104a in a wavelength range from 510 nm to 550 nm is ranged from 27% to 57%, or the transmittance of the aperture 104a in a wavelength range from 610 nm to 650 nm is ranged from 29% to 57%, so more laser light can penetrate through the aperture 104a. Although the transmittance of the aperture 104a is increased, the polarization ratio of light is not obviously changed. When the transmittance of the aperture 104a is less than 60%, the polarization ratio of light can still be greater than 95%, which will not affect the performance of the display device 10. Accordingly, the polarization ratio of the light and the performance of the display device 10 are not evidently influenced by the increase of the transmittance of the aperture 104a.

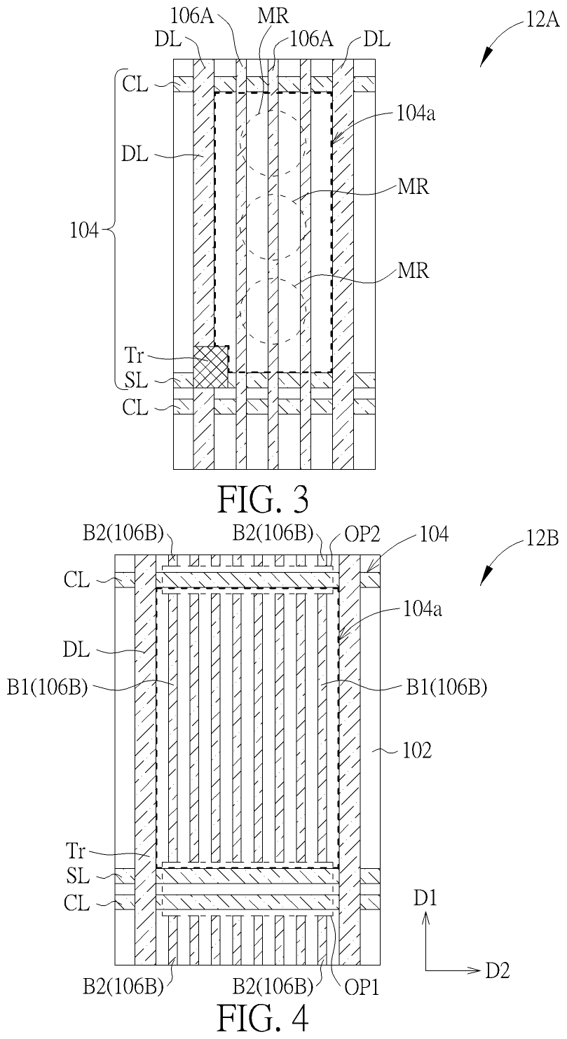

Refer to FIG. 3, which shows a method for measuring the transmittance of the aperture 104a according to the present disclosure. The method for measuring the transmittance of the aperture 104a may include the following steps. First step, light generated from a light source, for example a backlight unit, is provided to penetrate through the aperture 104a of the first array substrate 12A. Second step, a detector measures the intensity of the light at measuring regions MR, and a ratio of the intensity of the light after penetrating through the aperture 104a of to the intensity of the light before penetrating through the aperture 104a of can be calculated. The above-mentioned measuring steps may be for example performed at least three times. That is to say, at least three measuring regions MR may be located at a top portion of the aperture 104a, at a middle portion of the aperture 104a and at a bottom portion of the aperture 104a respectively, and the transmittance of the aperture 104a can be obtained by calculating the average of the transmittances. A cross-sectional size of measuring region MR may be ranged from 5 micrometers to 25 micrometers. In addition, the first array substrate 12A may further include transparent elements, and the transmittance of the aperture 104a of the first array substrate 12A is measured in consideration of the existence of the transparent elements. For example, the transparent elements may include pixel electrodes 108, a passivation layer 110, a gate insulating layer 112 and an alignment layer (not shown in figures). Since these elements are transparent and have transmittance greater than the polarizing wires 106A, the transmittance of the aperture 104a is mainly dominated by the polarizing wires 106A.

The display device 10 may further include a second array substrate opposite to the first array substrate and a liquid crystal layer disposed between the first array substrate and the second array substrate. The second array substrate may include a black matrix, a color conversion layer, or other layers or elements. The color conversion layer may be formed of a plurality of color filters or quantum dot patterns. The transmittance of the aperture 104a of the first array substrate 12A is measured without the second array substrate and the liquid crystal layer. The display device 10 of the present disclosure is not limited to be the LCD. In some embodiments, the display device may be an electrophoretic display (EPDs), or an electrowetting display (EWD). In some embodiments, the display device may be a self-luminous display without liquid crystal layer, such as an organic light emitting diode (OLED) display, a quantum dot light emitting diode (QLED) display, or a light emitting diode (LED) display (a mini LED display or a micro LED display), but the present disclosure is not limited thereto. In such situation, the electronic device may include or may not include the second array substrate.

Refer to FIG. 1 and FIG. 2 again. In this embodiment, no color conversion patterns are disposed in the apertures 104a. Accordingly, the transmittance of the aperture 104a in a wavelength range from 510 nm to 650 nm can be ranged from 34% to 57%. In this embodiment, the transmittance of the aperture 104a ranged from 34% to 57% may be achieved by adjusting a spacing between adjacent two of the polarizing wires 106A and a width of each polarizing wire 106A in the aperture 104a. Specifically, adjacent two of the polarizing wires 106A extending across the aperture 104a have a spacing S1 between them, and a first ratio of the spacing S1 to a width W1 of one of the polarizing wires 106A is ranged from 0.1 to 4, so that the transmittance of the aperture 104a in a wavelength range from 510 nm to 650 nm can be ranged from 34% to 57%. For example, the spacing S1 may be ranged from 50 nm to 200 nm, and the width W1 of the polarizing wire may be ranged from 50 nm to 500 nm.

In this embodiment, the transmittance of the aperture 104a ranged from 34% to 57% may optionally be achieved by adjusting a second ratio of the width W1 of one of the polarizing wires 106A to a thickness T1 of the polarizing wire 106A in the aperture 104a. Specifically, the second ratio is ranged from 0.06 to 10, so that the transmittance of the aperture 104a in a wavelength range from 510 nm to 650 nm can be ranged from 34% to 57%. For example, the thickness T1 of the polarizing wire 106A is ranged from 50 nm to 800 nm while the width W1 of the polarizing wire 106A is ranged from 50 nm to 500 nm. In another embodiment, the transmittance of the aperture 104a ranged from 34% to 57% may be achieved by complying with one of the first ratio and the second ratio.

Additionally, in this embodiment, the polarizing wires 106A may be formed of a metal layer M2A between the gate insulating layer 112 and the passivation layer 110 of the array substrate 12A, and the metal layer M2A may include molybdenum, aluminum, gold, silver, copper or titanium, in which since an extinction coefficient of aluminum is better of the above-mentioned materials. Since the polarizing wires 106A is formed of metal, no bubbles will be generated at high temperature and high humidity. In some embodiment, the polarizing wires 106A may be formed by other layers of the array substrate 12A or additional layers out of any layers of the array substrate 12A. The polarizing wires 106A may be single layered or multi layered. The metal layer M2A of this embodiment may also be used for forming the data lines DL and drains DE of the transistors Tr, in which the data line DL also includes source of the transistor Tr. The scan lines SL and the common lines CL are formed of another metal layer M1A. Also, the extending direction of polarizing wires 106A in the aperture 104a may be substantially parallel to an extending direction (that is the first direction D1) of data lines DL, but the present disclosure is not limited thereto. In some embodiment, the extending direction of polarizing wires 106A may be substantially parallel to an extending direction (that is the second direction D2) of scans lines SL or common lines CL. In some embodiment, the extending direction of polarizing wires 106A in the aperture 104a may be inclined to the first direction D1 or the second direction D2. Furthermore, in this embodiment, a profile of one of the polarizing wires 106A may be for example rectangular, but the present disclosure is not limited thereto. Specifically, the polarizing wires may be disposed between the substrate and the metal layer for forming the scan lines or disposed above the metal layer for forming the data lines. When the polarizing wires are formed between the substrate and the metal layer for forming the scan lines and the common lines, a planarization layer may be further provided between the polarizing wires and the metal layer. Alternatively, in another embodiment, the polarizing wires may be formed on a side of the substrate opposite to the other side for forming the array circuit (outer surface of the display device 10), so the substrate may be disposed between the polarizing wires and the array circuit. The polarizing wires may be electrically connected or electrically isolated.

The transmittance of the aperture 104a ranged from 34% to 57% maybe achieved by other method. Refer to FIG. 4, which schematically illustrates a top view of a first array substrate according to a variant embodiment of the first embodiment of the present disclosure. In the first array substrate 12B of this variant embodiment, the polarizing wires 106B may have at least one opening for separating, the opening is corresponding to the light-shielding elements. In this variant embodiment, the polarizing wires 106B are separated by a first opening OP1 and a second opening OP2, in which the first opening OP1 overlaps one of the scan lines SL and one of the common lines CL, and the second opening OP2 overlaps another one of the common lines CL. Specifically, the polarizing wires 106B may be separated into a plurality of first polarizing wires B1 and a plurality of second polarizing wires B2. Through disposing the first opening OP1 and the second opening OP2 in the polarizing wires 106B, the transmittance of the aperture 104a in a wavelength range from 510 nm to 650 nm can be increased to be in the range from 34% to 57%. In this variant embodiment, the first polarizing wires B1 are entirely within the one of the apertures 104a in a top view. In other words, one end of each first polarizing wire B1 is spaced apart from the corresponding scan line SL in the top view, and the other end of each first polarizing wire B1 is spaced apart from the corresponding common line CL in the top view. Since the polarizing wires 106B do not overlap the signal lines, electrically connection possibility between the polarizing wires 106B and the signal lines could be reduced. In another variant embodiment, the end of each first polarizing wire maybe aligned with a side of the corresponding scan line in the top view. The other end of each first polarizing wire may be optionally aligned with a side of the corresponding common line in the top view.

In another variant embodiment, the polarizing wires may include a third opening within one of the apertures 104a, the third opening is entirely disposed in the aperture 104a in the top view, and connection line of the ends of the polarizing wires at the third opening may be curved or straight in the top view.

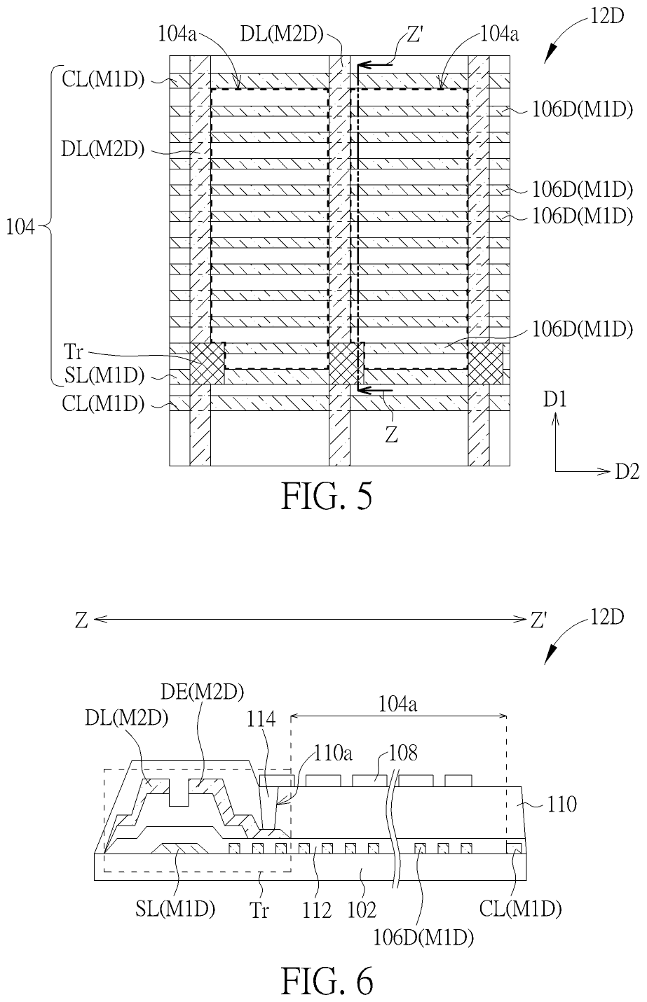

The extending direction of the polarizing wires in the aperture is not limited to the mentioned above. Refer to FIG. 5 and FIG. 6. FIG. 5 schematically illustrates a top view of a first array substrate according to a variant embodiment of the first embodiment of the present disclosure, and FIG. 6 schematically illustrates a cross-sectional view of the first array substrate taken along a line Z-Z′ shown in FIG. 5. In the first array substrate 12D of this variant embodiment, the extending direction of the polarizing wires 106D in the aperture 104a maybe the same as an extending direction (a second direction D2) of scan line SL. Also, the metal layer M1D forming the polarizing wires 106D may be used for forming the scan lines SL and the common lines CL and be disposed between the gate insulating layer 112 and the substrate 102, and the data lines DL and the drains DE of the transistors Tr are formed of another metal layer M2D. The polarizing wires 106D may be electrically connected or electrically isolated. In addition, the polarizing wires 16D may be connected to the common lines CL or the ground is facilitated.

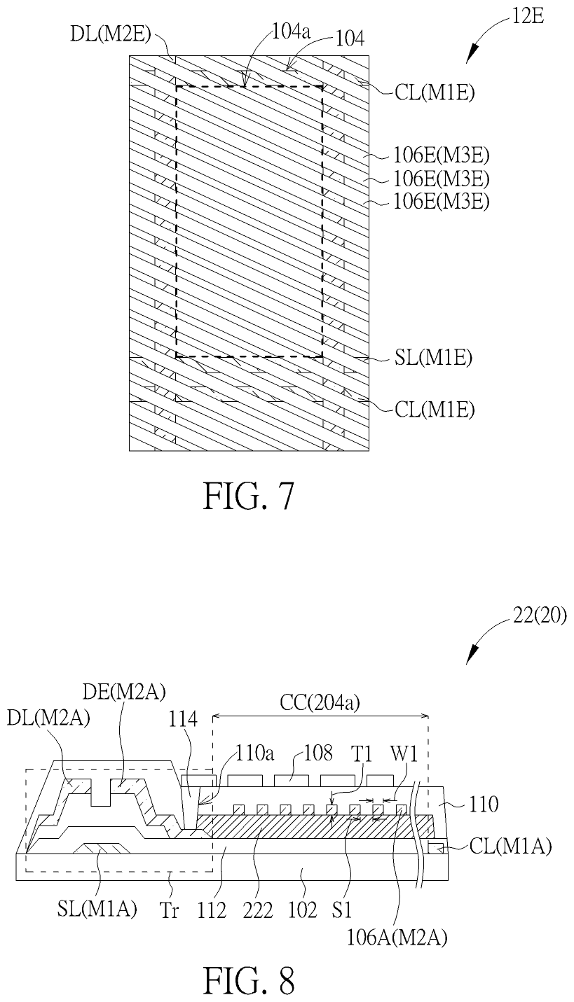

Refer to FIG. 7, which schematically illustrates a top view of a first array substrate according to a variant embodiment of the first embodiment of the present disclosure. In the first array substrate 12E of this variant embodiment, extending direction of the polarizing wires 106E is inclined to the first direction D1 or the second direction D2. The polarizing wires 106E are formed of the metal layer M3E may not be the same as the metal layer M2E for forming the data lines DL and drains DE of the transistors Tr and the metal layer M1E for forming the scan lines SL and the common lines CL.

The profile of the polarizing wire is not limited to be the above-mentioned rectangular. The profile of the polarizing wire may be direct-trapezoid-shaped, inverted-trapezoid shape, or combine with a dome-shaped portion with curved surface. Since the direct-trapezoid-shaped surface, the inverted-trapezoid shape surface, or the dome-shaped top surface will cause the light to be diverged when the light penetrates through the gap between two of the polarizing wires, through the design of this embodiment, a diverged angle between the propagation direction of the light and a propagation direction of diverged light can be less than or equal to 0.5 degree, thereby providing a collimator light and enhancing the polarization ratio.

Refer to FIG. 2, in the region A, a protection layer may be disposed on the polarizing wires 106A or disposed between the substrate 102 and the polarizing wires 106A. In which the protection layer covers the polarizing wires 106A, so as to protect the polarizing wires 106A from oxidation that will degrade the polarization effect of the polarizing wires 106A. The protection layer may include a silicon nitride layer 116 or a silicon oxide layer 118. The thickness of the polarizing wire 106A is greater than a thickness of the silicon nitride layer 116 or the silicon oxide layer 118, so that the effect of the silicon nitride layer 116 and the silicon oxide layer 118 on the polarization can be mitigated.

Refer to FIG. 8, which schematically illustrates a cross-sectional view of a first array substrate of an electronic device according to a second embodiment of the present disclosure. In this embodiment, the electronic device is a display device 20. As compared with the first embodiment shown in FIG. 1 and FIG. 2, the apertures 204a of this embodiment includes a color conversion region CC for allowing the light with the wavelength range from 510 nm to 550 nm or the wavelength range from 610 nm to 650 nm penetrating through. Specifically, the first array substrate 22 of the display device 20 further includes a color conversion layer 222 covering the color conversion region CC, and the color conversion layer 222 is for example a green color filter layer for the wavelength range from 510 nm to 550 nm or a red color filter for the wavelength range from 610 nm to 650 nm, a green or red phosphor layer or a quantum dot layer for generating green light or red light. The display device 20 may be called “color filter on array (COA)” type. In this embodiment, since the color conversion layer 222 allows the light with the wavelength from 510 nm to 550 nm penetrating through, the transmittance of the color conversion region CC in a wavelength range from 510 nm to 550 nm is ranged from 27% to 52%, and since the color conversion layer 222 allows the light with the wavelength from 610 nm to 650 nm penetrating through, the transmittance of the color conversion region CC in a wavelength range from 610 nm to 650 nm is ranged from 29% to 52%. Thus, the display device 20 is adapted to the laser repair using the laser light with the wavelength range from 510 nm to 550 nm or from 610 nm to 650 nm. The color conversion layer 222 may be disposed between the polarizing wires 106A and the substrate 102, but the present disclosure is not limited thereto. In addition, the transmittance of the color conversion region CC may be achieved by the method of the above-mentioned embodiments. In this embodiment, the second array substrate (not shown in FIG. 8) of the display device 20 may not have the color conversion layer. In another variant embodiment, when the color conversion layer is the color filter, the polarizing wires may be disposed between the color conversion layer and the substrate.

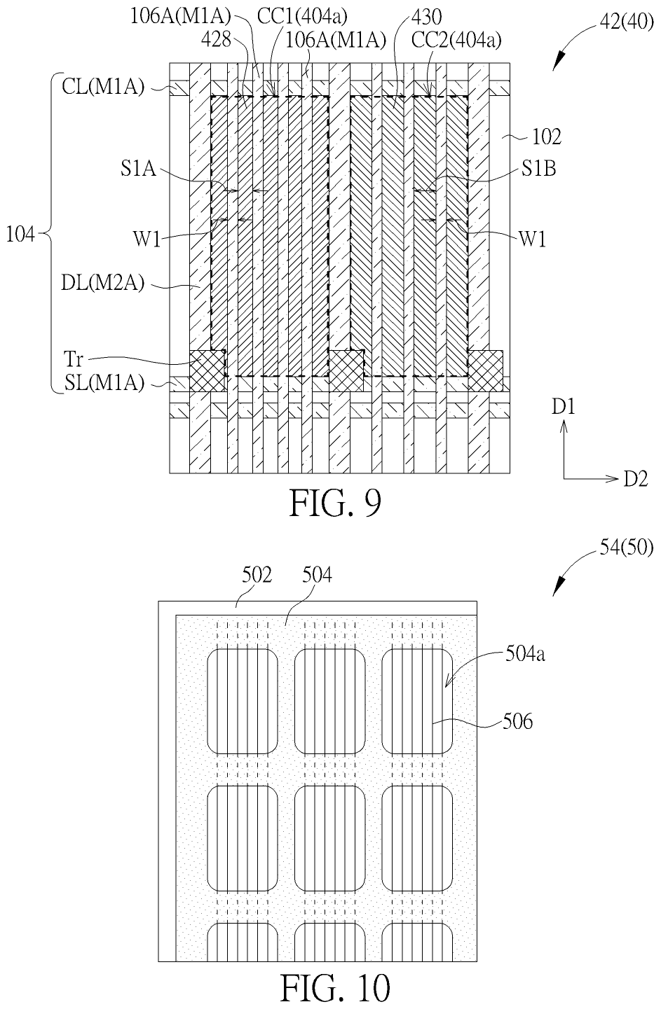

Refer to FIG. 9, which schematically illustrates a top view of a first array substrate of an electronic device according to a third embodiment of the present disclosure. In this embodiment, the electronic device is a display device 40. As compared with the first embodiment shown in FIG. 1 and FIG. 2, the apertures 404a of the grid structure 404 provided in this embodiment includes a first color conversion region CC1 for allowing the light with the wavelength range from 510 nm to 550 nm penetrating through and a second color conversion region CC2 for allowing the light with the wavelength range from 610 nm to 650 nm penetrating through. Specifically, the display device 40 may further include a first color conversion layer 428 covering the first color conversion region CC1 and a second color conversion layer 430 covering the second color conversion region CC2. The first color conversion layer 428 and the second color conversion layer 430 may be the same as the color conversion layer 222 of the second embodiment. In this embodiment, the transmittance of the first color conversion region CC1 in a wavelength range from 510 nm to 550 nm is ranged from 27% to 52%, and, the transmittance of the second color conversion region CC2 of this embodiment in a wavelength range from 610 nm to 650 nm is ranged from 29% to 52%. It should be noted that in this embodiment, the spacing S1A between adjacent two of the polarizing wires 106A in the first color conversion region CC1 may be less than the spacing S1B between adjacent two of the polarizing wires 106A in the second color conversion region CC2 while the width W1 of each polarizing wire 106A in the first color conversion region CC1 is the same as the width W1 of each polarizing wire 106A in the second color conversion region CC2. In this embodiment, the second array substrate (not shown in FIG. 9) of the display device 40 may not have the color conversion layer.

Refer to FIG. 10 and FIG. 11. FIG. 10 schematically illustrates a top view of a second array substrate of an electronic device according to a fourth embodiment of the present disclosure, and FIG. 11 schematically illustrates a cross-sectional view of the second array substrate shown in FIG. 10. In this embodiment, the electronic device is a display device 50. As compared with the first embodiment shown in FIG. 1 and FIG. 2, the grid structure 504 of the display device 50 provided in this embodiment is formed by a black matrix, so one of the apertures 504a is formed by an opening within the black matrix. For example, the grid structure 504 maybe included in a second array substrate 54 that doesn't include the array circuit. In this embodiment, color conversion layers (not shown in FIG. 10 and FIG. 11) are disposed in the first array substrate. Accordingly, the transmittance of the aperture 504a in a wavelength range from 510 nm to 650 nm can be ranged from 34% to 57%. The transmittance of the aperture 504a ranged from 34% to 57%. The polarizing wires 506 may be adapted to the polarizing wires of any one of the above-mentioned embodiments or variant embodiments. In this embodiment, the color conversion layers may be located on the first array substrate.

In this embodiment, the grid structure 504 may be disposed between the polarizing wires 506 and the substrate 502. More specifically, the second array substrate 54 may optionally further include a planarization layer 532 between the polarizing wires 506 and the grid structure 504 to keep the polarization of the polarizing wires 506 from being reduced by the uneven polarizing wires. Also, the second array substrate 54 may further include the protection layer PL1, and the polarizing wires 506 are disposed between the protection layer PL1 and the planarization layer 532 and the protection layer PL1. The protection layer PL1 may be the same as the mentioned above, and will not be redundantly detailed. In another variant embodiment, the polarizing wires may be disposed between the grid structure and the substrate.

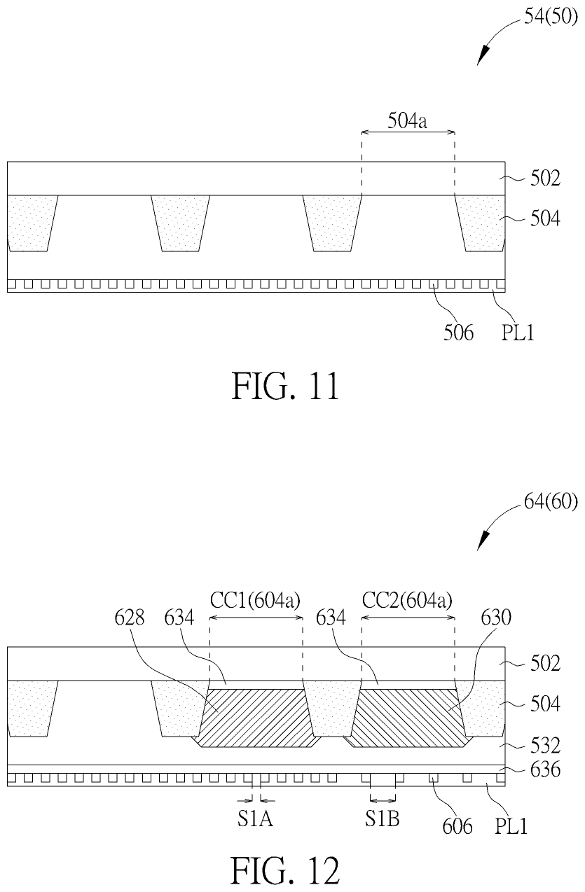

Refer to FIG. 12, which schematically illustrates a cross-sectional view of a second array substrate of a display device according to a fifth embodiment of the present disclosure. As compared with previous embodiment shown in FIG. 10 and FIG. 11, the apertures 604a of this embodiment includes a first color conversion region CC1 for allowing the light with the wavelength from 510 nm to 550 nm penetrating through and a second color conversion region CC2 for allowing the light with the wavelength range from 610 nm to 650 nm penetrating through. Specifically, the second array substrate 64 of the display device 60 may include a first color conversion layer 628 covering the first color conversion region CC1 and a second color conversion layer 630 covering the second color conversion region CC2. The first color conversion layer 628 and the second color conversion layer 630 allow light with different colors penetrating through. In this embodiment, the transmittance of the first color conversion region CC1 in a wavelength range from 510 nm to 550 nm is ranged from 27% to 52%, and the transmittance of the second color conversion region CC2 of this embodiment in a wavelength range from 610 nm to 650 nm is ranged from 29% to 52%. The polarizing wires 606 may be adapted to the polarizing wires of any one of the above-mentioned embodiments or variant embodiments. In this embodiment, the spacing S1A between adjacent two of the polarizing wires 606 in the first color conversion region CC1 may optionally be less than the spacing S1B between adjacent two of the polarizing wires 606 in the second color conversion region CC2. In this embodiment, the second array substrate (not shown in FIG. 12) of the display device 60 may not have the color conversion layer.

In this embodiment, the second array substrate 64 may optionally further include a first transflective layer 634, such as Bragg structure layer, disposed between the first color conversion layer 628 and the substrate 502 and between the second color conversion layer 630 and the substrate 502 and a second transflective layer 636 between the planarization layer 532 and the polarizing wires 606, so as to enhance the color purity of the output light. In another embodiment, when the first color conversion layer 628 and the second color conversion layer 630 are color filter layers, the polarizing wires 606 may be disposed between the first color conversion layer 628 and the substrate 502 and between the second color conversion layer 630 and the substrate 502.

Refer to FIG. 13, which schematically illustrates a cross-sectional view of a second array substrate of an electronic device according to a sixth embodiment of the present disclosure. In this embodiment, the electronic device is a display device 70. As compared with the previous embodiment shown in FIG. 12, the metal layer M1H for forming the polarizing wires 706 of the display device 70 provided in this embodiment may include at least one block 738 shielded by the grid structure 704 in the top view (the normal direction of the substrate 502). The block 738 may be disposed between two adjacent polarizing wires 706 and used to electrically connect the polarizing wires 706 corresponding to the same aperture 704a to each other, thereby facilitating the electrical connection of polarizing wires 706 to the common lines or the ground. In this embodiment, the polarizing wires 706 maybe disposed between the first color conversion layer 728 and the substrate 702 and between the second color conversion layer 730 and the substrate 502. In a variant embodiment, the first color conversion layer and the second color conversion layer may be disposed between the polarizing wires and the substrate. In such situation, a planarization layer may be optionally disposed between the polarizing wires and the grid structure. In this embodiment, the second array substrate 74 may not include the first transflective layer and the second transflective layer. In another variant embodiment, the second array substrate may further include the first transflective layer disposed between the first color conversion layer and the substrate and between the second color conversion layer and the substrate and the second transflective layer between the planarization layer and the polarizing wires.

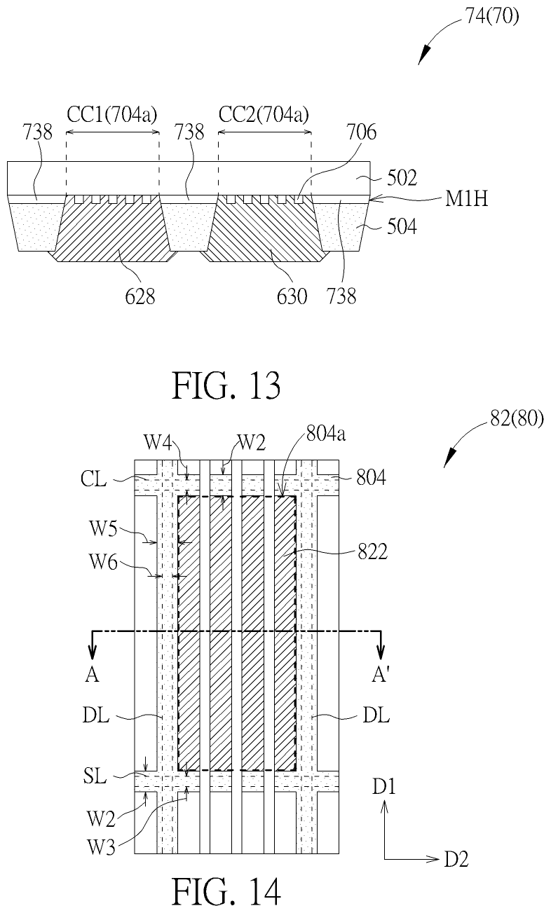

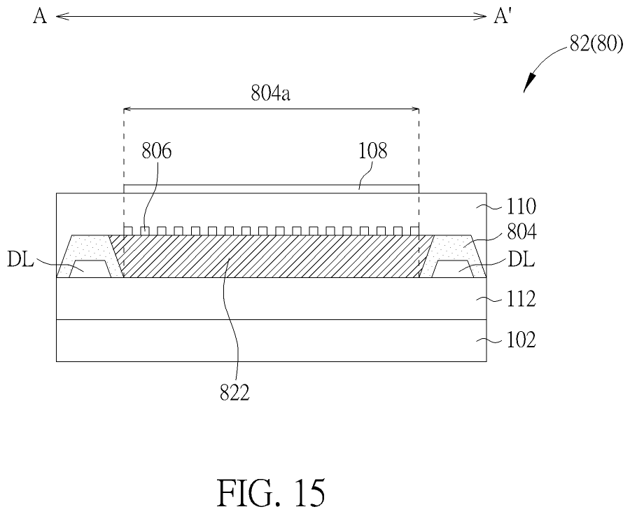

Refer to FIG. 14 and FIG. 15. FIG. 14 schematically illustrates a top view of a first array substrate of an electronic device according to a seventh embodiment of the present disclosure, and FIG. 15 schematically illustrates a cross-sectional view of the first array substrate taken along a line A-A′ shown in FIG. 14. In this embodiment, the electronic device is a display device 80. As compared with the first embodiment shown in FIG. 1 and FIG. 2, the black matrix BM of the display device 80 provided in this embodiment is included in the first array substrate 82, and the black matrix BM is disposed on the same array substrate with array circuit. Specifically, the display device 80 may be called “black matrix on array (BOA)” type. The grid structure 804 is formed by the black matrix, so the grid structure 804 covers the light shielding elements, such as the scan lines SL, the common lines CL and the data lines DL, but not limited thereto. Specifically, a width W2 of the grid structure 804 in the first direction D1 is greater than a width W3 of one of the scan lines SL and greater than a width of W4 of one of the common lines CL, and a width W5 of the grid structure 804 in the second direction D2 is greater than a width W6 of one of the data lines DL. In this embodiment, the grid structure 804 may be disposed on the gate insulating layer 112, but the present disclosure is not limited thereto. Also, the data lines DL may be optionally disposed between the grid structure 804 and the gate insulating layer 112, but not limited thereto.

Furthermore, the apertures 804a of the grid structure 804 may include a first color conversion region CC1 for allowing the light with the wavelength range from 510 nm to 550 nm or the wavelength range from 610 nm to 650 nm penetrating through. Specifically, the first array substrate 82 of the display device 80 further includes a color conversion layer 822 covering the color conversion region, and the color conversion layer 822 is for example a green color filter layer, a green phosphor layer, a quantum dot layer for generating green light, a red color filter layer, a red phosphor layer or a quantum dot layer for generating red light. The transmittance of the color conversion region in a wavelength range from 510 nm to 550 nm is ranged from 27% to 52%, and the transmittance of the color conversion region in a wavelength range from 610 nm to 650 nm is ranged from 29% to 52%, which maybe achieved by the same method as the above-mentioned embodiments or variant embodiments and will not be detailed. In this embodiment, the color conversion layer 822 may be disposed between the substrate 802 and the polarizing wires 806. Also, the polarizing wires 806 disposed on the color conversion layer 822 may be adapted to the polarizing wires of any one of the above-mentioned embodiments or variant embodiments. In a variant embodiment, when the color conversion layer is the color filter, the color conversion layer may be disposed on the polarizing wires. In another variant, the first array substrate may not include the color conversion layer while the first array substrate includes the black matrix.

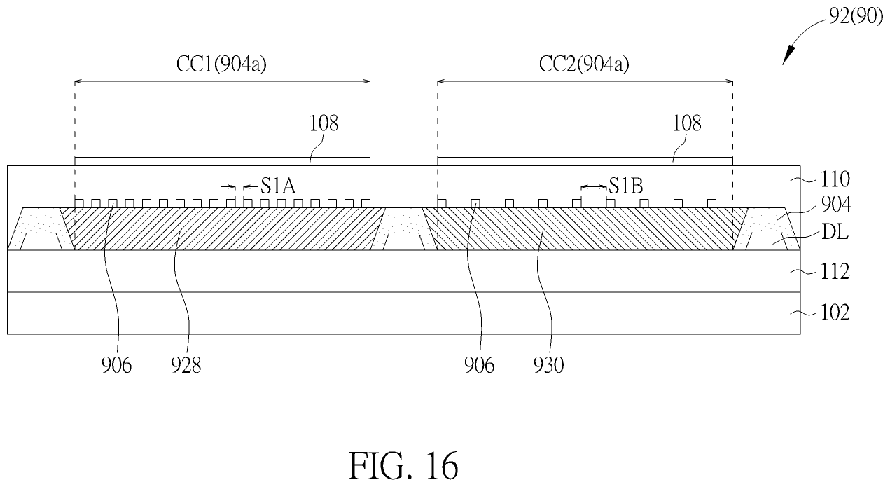

Refer to FIG. 16, which schematically illustrates a cross-sectional view of a first array substrate of an electronic device according to an eighth embodiment of the present disclosure. In this embodiment, the electronic device is a display device 90. As compared with the eighth embodiment shown in FIG. 14 and FIG. 15, the apertures 904a of the display device 90 provided in this embodiment includes a first color conversion region CC1 for allowing the light with the wavelength range from 510 nm to 550 nm penetrating through and a second color conversion region CC2 for allowing the light with the wavelength range from 610 nm to 650 nm penetrating through, in which the transmittance of the first color conversion region CC1 in a wavelength range from 510 nm to 550 nm is ranged from 27% to 52%, and the transmittance of the second color conversion region CC2 of this embodiment in a wavelength range from 610 nm to 650 nm is ranged from 29% to 52%, which may be achieved by the same method as the above-mentioned embodiments or variant embodiments and will not be detailed. Specifically, the first array substrate 92 may further include a first color conversion layer 928 covering the first color conversion region CC1 and a second color conversion layer 930 covering the second color conversion region CC2. Also, the grid structure 904 may be formed of black matrix. In this embodiment, the spacing S1A between adjacent two of the polarizing wires 906 in the first color conversion region CC1 maybe less than the spacing S1B between adjacent two of the polarizing wires 906 in the second color conversion region CC2. The polarizing wires 906 may be adapted to the polarizing wires of anyone of the above-mentioned embodiments or variant embodiments. In this embodiment, the second array substrate may not include the color conversion layer and the black matrix.

According to the present disclosure, the transmittance of the aperture in a wavelength range from 510 nm to 550 nm is increased to be ranged from 27% to 57%, or the transmittance of the aperture in a wavelength range from 610 nm to 650 nm is increased to be ranged from 29% to 57%, so more laser light with a wavelength ranged from 510 nm to 550 nm or with a wavelength ranged from 610 nm to 650 nm can penetrate through the aperture, thereby improving the effect of the laser repair under the condition without obviously changing the polarization ratio of light. According some embodiments, the transmittance of the aperture may be achieved by adjusting a first ratio of the spacing between adjacent two of the polarizing wires to the width of each polarizing wire in the aperture(that is ranged from 0.1 to 4), by adjusting a second ratio of the width of each polarizing wire to the thickness of each polarizing wire in the aperture (that is ranged from 0.06 to 10), or by disposing the first opening or the second opening in the polarizing wires or disposing the third opening in the polarizing wires.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a substrate;
a grid structure disposed on the substrate and comprising a plurality of apertures; and
a plurality of polarizing wires disposed on the substrate and extending across the plurality of apertures;
wherein a transmittance of one of the plurality of apertures in a wavelength range from 510 nm to 550 nm is ranged from 27% to 57%.

2. The electronic device of claim 1, wherein the plurality of apertures further comprises a first color conversion region, wherein a transmittance of the first color conversion region in the wavelength range from 510 nm to 550 nm is ranged from 27% to 52%.

3. The electronic device of claim 2, wherein the plurality of apertures further comprises a second color conversion region, wherein a transmittance of the second color conversion region in a wavelength range from 610 nm to 650 nm is ranged from 29% to 52%.

4. The electronic device of claim 3, wherein a first spacing between adjacent two of the polarizing wires in the first color conversion region is less than a second spacing between adjacent two of the polarizing wires in the second color conversion region.

5. The electronic device of claim 1, wherein the plurality of apertures further comprises a region without converting color of light, wherein a transmittance of the region in a wavelength range from 510 nm to 650 nm is ranged from 34% to 57%.

6. The electronic device of claim 1, wherein the grid structure is formed by a plurality of scan lines and a plurality of data lines.

7. The electronic device of claim 1, wherein the grid structure is formed by a black matrix.

8. The electronic device of claim 1, wherein a first ratio of a spacing between adjacent two of the plurality of polarizing wires to a width of one of the plurality of polarizing wires is ranged from 0.1 to 4.

9. The electronic device of claim. 1, wherein a second ratio of a width of one of the plurality of polarizing wires to a thickness of the one of the plurality of polarizing wires is ranged from 0.06 to 10.

10. An electronic device, comprising:
a substrate;
a grid structure disposed on the substrate and comprising a plurality of apertures; and
a plurality of polarizing wires disposed on the substrate and extending across the plurality of apertures;
wherein a transmittance of one of the plurality of apertures in a wavelength range from 610 nm to 650 nm is ranged from 29% to 57%.

11. The electronic device of claim 10, wherein the plurality of apertures further comprises a second color conversion region, wherein a transmittance of the second color conversion region in the wavelength range from 610 nm to 650 nm is ranged from 29% to 52%.

12. An electronic device, comprising:
a substrate;
a plurality of scan lines disposed on the substrate;
a plurality of data lines disposed on the substrate;
a black matrix disposed on the substrate and comprising a plurality of apertures; and
a plurality of polarizing wires disposed on the substrate and extending across the plurality of apertures;
wherein a transmittance of one of the plurality of apertures in a wavelength range from 510 nm to 550 nm is ranged from 27% to 57%.

13. The electronic device of claim 12, wherein the plurality of apertures further comprises a first color conversion region, wherein a transmittance of the first color conversion region in the wavelength range from 510 nm to 550 nm is ranged from 27% to 52%.

14. The electronic device of claim 13, wherein the plurality of apertures further comprises a second color conversion region, wherein a transmittance of the second color conversion region in a wavelength range from 610 nm to 650 nm is ranged from 29% to 52%, and a first spacing between adjacent two of the polarizing wires in the first color conversion region is less than a second spacing between adjacent two of the polarizing wires in the second color conversion region.

15. An electronic device, comprising:
a substrate;
a plurality of scan lines disposed on the substrate;
a plurality of data lines disposed on the substrate;
a black matrix disposed on the substrate and comprising a plurality of apertures; and
a plurality of polarizing wires disposed on the substrate and extending across the plurality of apertures;
wherein a transmittance of one of the plurality of apertures in a wavelength range from 610 nm to 650 nm is ranged from 29% to 57%.

16. The electronic device of claim 15, wherein the plurality of apertures further comprises a second color conversion region, wherein a transmittance of the second color conversion region in the wavelength range from 610 nm to 650 nm is ranged from 29% to 52%.

17. The electronic device of claim 15, wherein the plurality of apertures further comprises a first color conversion region, wherein a transmittance of the first color conversion region in a wavelength range from 510 nm to 650 nm is ranged from 27% to 52%, and a first spacing between adjacent two of the polarizing wires in the first color conversion region is less than a second spacing between adjacent two of the polarizing wires in the second color conversion region.
